(19) United States
(12) Patent Application Publication
(10) Pub. No.: US 2022/0203656 A1
(43) Pub. Date: Jun. 30, 2022

(54) TEXTILE ELEMENTS IN VEHICLE COMPOSITE GLASS

(71) Applicant: SAINT-GOBAIN GLASS FRANCE, COURBEVOIE (FR)

(72) Inventors: Martin LAKSHMANAN, AACHEN (DE); Oriane GARCIA, CARACASSONNE (FR); Johannes WOLF, AACHEN (DE)

(21) Appl. No.: 17/604,242

(22) PCT Filed: Apr. 7, 2020
(86) PCT No.: PCT/EP2020/059910

§ 371 Date: Oct. 15, 2021

(30) Foreign Application Priority Data
Apr. 16, 2019 (EP) 19169369.6

(51) Int. Cl. B32B 17/10

(52) U.S. Cl. CPC B32B 17/10247; B32B 17/10036; B32B 17/10064; B32B 17/10366; B32B 2605/08; B32B 2307/41; B32B 2260/021; B32B 2260/046; B32B 2262/106; B32B 2307/4026; B32B 2250/03

(57) ABSTRACT

A vehicle composite glass includes an outer pane, an inner pane, at least one polymeric intermediate layer which is arranged between the outer pane and the inner pane, and a textile film which includes a textile in a plastic matrix, wherein the textile film is adhered on a sub-region of the outer pane or the inner pane of the vehicle composite glass or is laminated in a sub-region between the polymeric intermediate layer and the outer pane or the inner pane. The vehicle composite glass has an attractive design with, at the same time, increased mechanical stiffness. The textile film can also serve as visual cover such that the otherwise customary black masking print is not required.

The invention relates to vehicle composite glasses, in particular automobile glazings.

A composite glass comprises two glass panes that are firmly bonded to one another by a transparent plastic intermediate layer. In the event of breakage, the glass pieces adhere to the intermediate layer. Such safety glasses are used extensively, e.g., as vehicle glazing and in the construction industry.

In the case of vehicle windows in particular, the composite glass is generally provided with an opaque coating at the side edge, usually a black print, as a design element that usually runs around the entire side edge of the composite glass. The opaque coating or the black print itself is generally not perceived as visually attractive, but is used to visually conceal unsightly parts required for installation in a vehicle, such as mechanical parts, seals, glued bonds, or cables.

Such an opaque coating requires an additional production step. Moreover, the opaque coating has a different coefficient of thermal expansion from the vehicle composite glass, which can, in the event of temperature changes, result in mechanical stress or even thermal breakage. Also a problem is the thermal load required during baking of the black print, which is usually formed from a ceramic ink.

There is a need for vehicle composite glasses having a more visually attractive design.

Depending on the intended application, vehicle composite glasses must also meet certain stiffness requirements. This is generally achieved by using panes with a suitable thickness. Any measure that otherwise increases the stiffness of a vehicle composite glass is desirable, as this enables the use of panes with a lower thickness, which is advantageous in particular in terms of reduced weight.

In the course of the development of lightweight roof structures, the reduction of glass thickness results, for example, in lower mechanical strength. With regard to the aerodynamic lift of the roof at high speeds of the vehicle, the roof with reduced mechanical stiffness is prone to water tightness problems and increased risk of breakage. Consequently, the edges should be reinforced to achieve weight reduction and greater stiffness of the structure.

The present invention was made in light of the prior art described above. In particular, the object of the present invention was to provide a vehicle composite glass that has a visually attractive design, while at the same time increased stiffness of the composite glass is to be achieved. Optionally, it should also be made possible to avoid the otherwise customary black print at the side edge of the vehicle composite glass.

The object of the present invention is accomplished according to the invention by a vehicle composite glass in accordance with claim 1. Preferred embodiments emerge from the dependent claims.

The invention thus relates to a vehicle composite glass, comprising an outer pane, an inner pane, at least one polymeric intermediate layer which is arranged between the outer pane and the inner pane, and a textile film which includes a colored or dyed textile in a plastic matrix, wherein the textile film is adhered on a sub-region of the outer pane or the inner pane of the vehicle composite glass or is laminated in a sub-region between the polymeric intermediate layer and the outer pane or the inner pane.

It goes without saying that the textile film that is adhered on a sub-region of the outer pane or the inner pane of the vehicle composite glass or is laminated in a sub-region between the polymeric intermediate layer and the outer pane or the inner pane does not extend beyond the outer pane and the inner pane of the vehicle composite glass and also does not enclose one or more side edges of the outer pane or the inner pane.

The invention makes it possible to create a vehicle composite glass with an attractive design. Production is simple and can be carried out economically. The opaque coating in the edge region, in particular in the form of a black print, otherwise required to mask unsightly elements can, if necessary, be replaced by the textile film, which can also serve as visual cover. As a result, the disadvantages associated with such coatings can be avoided and the costs for the coating are saved.

At the same time, use of the textile film achieves not only a decorative design but also increased mechanical strength or mechanical stiffness of the vehicle composite glass, in particular when the textile film is laminated into the vehicle composite glass. The increased mechanical stiffness of the system due to the textile film also enables the use of panes with lower thickness than with prior art vehicle composite glasses without textile film without negatively affecting mechanical stiffness. This enables advantageous weight savings through the use of thinner panes.

The invention is explained in detail in the following. Apart from the textile film, the arrangements of the layers and materials used for them correspond to those of customary vehicle composite glasses.

The vehicle composite glass comprises an outer pane and an inner pane laminated to form a solid composite by at least one polymeric intermediate layer arranged between the outer pane and the inner pane.

In the context of the invention, “inner pane” refers to the pane that is intended, when installed, as the pane of the vehicle composite glass facing the interior, e.g., a vehicle interior. “Outer pane” refers to the pane intended, when installed, as the pane facing the external environment. The vehicle composite glass can be a flat or curved vehicle composite glass.

The inner pane and the outer pane can be made of the same material or of different materials. The inner pane and the outer pane can be made of inorganic glass and/or organic glass (polymers), with inorganic glass preferred. In a preferred embodiment, the inner pane and/or the outer pane contains flat glass, quartz glass, borosilicate glass, soda lime glass, alkali aluminosilicate glass, polycarbonate, and/or polymethacrylate. The inner pane and the outer pane are preferably made of soda lime glass.

The inner pane and the outer pane can have the same thickness or different thicknesses. Preferably, the inner pane and the outer pane have, independently of one another, a thickness in the range from 0.4 to 5.0 mm, e.g., 0.4 to 3.9 mm, more preferably from 1.6 to 2.5 mm. For mechanical reasons, the outer pane is preferably thicker than or the same thickness as the inner pane. For example, the outer pane is 2.1 mm thick; and the inner pane, 1.6 mm thick. The use according to the invention of the textile film increases the mechanical stiffness and thus enables the use of thinner panes

The inner pane and/or the outer pane can have other suitable functional layers, known per se in the form of coatings, e.g., nonstick coatings, tinted coatings, infrared reflecting coatings, e.g., as a metal coating, anti-scratch coatings, or low-E coatings.

The vehicle composite glass further includes at least one polymeric intermediate layer between the inner pane and the outer pane. Preferably, the at least one polymeric intermediate layer contains a thermoplastic polymer. Usually, appropriate commercially available laminating films are used as the starting material for forming the at least one polymeric intermediate layer. They are used for bonding or laminating the components of the vehicle pane to obtain the adhesive glass bond. The at least one polymeric intermediate layer is, in particular, transparent, preferably can be clear, i.e., colorless, or tinted.

The at least one polymeric intermediate layer can contain or be made of, for example, polyvinyl butyral (PVB), ethylene vinyl acetate, polyurethane, polypropylene, polyacrylate, polyethylene, polycarbonate, polymethyl methacrylate, polyvinyl chloride, polyacetate resin, casting resin, acrylate, fluorinated ethylene propylene, polyvinyl fluoride, and/or ethylene tetrafluoroethylene and/or a mixture and/or a copolymer thereof. Preferably, the polymeric intermediate layer contains polyvinyl butyral (PVB), ethylene vinyl acetate, polyurethane, and/or mixtures thereof and/or copolymers thereof, with PVB laminating layers being particularly preferred.

The at least one polymeric intermediate layer, preferably in the form of a PVB layer, preferably has a thickness of 0.04 to 1.5 mm, preferably 0.1 to 1.2 mm, even more preferably from 0.3 to 0.9 mm, for example, 0.38 mm or 0.76 mm.

The vehicle composite glass further includes a textile film that comprises a textile in a plastic matrix. A wide variety of such textile films are commercially available.

The textile ist preferably a sheetlike textile. The textile is formed from colored or dyed fibers. The fibers can be inorganic or organic fibers, with inorganic fibers being preferred. Examples of suitable fibers include carbon fibers, glass fibers, or aramide fibers, such as poly(p-phenylene terephthalamide) fibers (PPT fibers), with textiles made from carbon fibers being particularly preferred. Carbon fibers are particularly advantageous since they are lightweight and particularly aesthetically attractive textiles can be obtained. Also, due to their intrinsic coloration, no additional dying is required.

According to the invention, the textile is colored or dyed, i.e., the textile is not colorless. Thus, for example, the textile is not a colorless glass fiberweb.

The textile is preferably formed from black fibers, e.g., carbon fibers or black dyed fibers, such as black glass fibers. A good level of optical masking can be achieved with black fibers, and a particularly decorative appearance can be obtained. The visual appearance achievable with black textiles is well-suited for technical products in the vehicle sector. Of course, in addition to black fibers, fibers with other colors are also conceivable.

The textile or sheetlike textile, preferably made of carbon fibers, can, for example, be a laid, woven, knitted, or crocheted fabric, with a woven fabric being particularly preferred. This facilitates, if need be, the forming of optical patterns in the textile, further enhancing the decorative effect.

The textile or the sheetlike textile is situated in a plastic matrix, usually being completely embedded in the plastic matrix. The plastic matrix is in particular transparent such that the textile is visible as a decorative element. The plastic for the plastic matrix can include all plastics used for commercially available textile films, such as polyester resins, vinyl ester resins, and epoxy resins, with epoxy resins being preferred.

The thickness of the textile film can be adapted to the intended use and is, for example, in the range from 0.05 to 2 mm, preferably from 0.1 to 1 mm, more preferably 0.1 to 0.6 mm.

In a preferred embodiment of the invention, the textile film is a carbon fiber film. Carbon fiber films are relatively light and allow a particularly decorative appearance. Moreover, carbon fiber films are commercially available in many different thicknesses and patterns.

The textile film can be partially translucent or transparent or opaque. In a preferred embodiment, the textile film is opaque. An opaque textile film can serve as visual cover to visually conceal unsightly parts, e.g., mechanical parts, seals, glued bonds, or cables, that are required for installation in the vehicle, and thus replace the black masking print on the vehicle composite glass customarily used for this purpose. The above-described disadvantages of such opaque coatings are avoided. Thin textile films are usually partially translucent such that a black masking print can still be required for complete masking.

Two variants are possible for bonding the textile film to the vehicle composite glass. In one embodiment, the textile film is adhered on a sub-region of the outer pane or the inner pane of the vehicle composite glass, preferably on a sub-region of the outer pane. This is very easy and economical to implement and has, above all, decorative advantages. An improvement of the mechanical rigidity of the vehicle composite glass is likewise achieved.

To form such a vehicle composite glass, a conventional vehicle composite glass is provided. The textile film is trimmed to size according to the shape of the sub-region that is to be provided with the textile film and then bonded using adhesive to the intended sub-region of the outer pane of the vehicle composite glass or the inner pane of the vehicle composite glass. Commercially available adhesives, e.g., epoxy adhesive, silicon adhesive, or polyurethane adhesive, can be used as adhesive.

In an alternative embodiment, the textile film is laminated in a sub-region between the polymeric intermediate layer and the outer pane or between the polymeric intermediate layer and the inner pane. Here as well, decorative advantages result from a visually attractive appearance. At the same time, the rigidity of the vehicle composite glass is increased even more significantly than with simple adhesive bonding of the textile film to the vehicle composite glass. The textile film is preferably laminated between the polymeric intermediate layer and the outer pane.

In the alternative embodiment, it is preferable, when the textile film is laminated between the polymeric intermediate layer and the outer pane, to arrange an additional polymeric bonding layer between the textile film and the outer pane or, when the textile film is laminated between the polymeric intermediate layer and the inner pane, to arrange an additional polymeric bonding layer between the textile film and the inner pane.

The polymeric bonding layer can be implemented over the entire surface in the vehicle composite glass or over only part of the surface in the sub-region of the textile film.

The polymeric bonding layer is preferably thermoplastic. All materials mentioned above for the polymeric intermediate layer can be considered as materials for the polymeric bonding layer such that reference is made thereto. The polymeric bonding layer is also preferably a PVB layer. The polymeric bonding layer is also, in particular, transparent. The thickness of the polymeric bonding layer can be within the ranges mentioned above for the polymeric intermediate layer such that reference is made thereto. In general, the polymeric bonding layer preferably has a lower thickness than the polymeric intermediate layer.

To form a vehicle composite glass with a textile film laminated therein, the textile film is trimmed according to the shape of the sub-region that is to be provided with the textile film. To form the vehicle composite glass, an arrangement of an outer pane, a polymeric intermediate layer film, and an inner pane is first formed, wherein, furthermore, the trimmed-to-size textile film is arranged in a sub-region between the polymeric intermediate layer film and the outer pane or between the polymeric intermediate layer film and the inner pane. Preferably, another polymeric bonding film can additionally be inserted into the arrangement such that the textile film is positioned between the polymeric intermediate layer film and the polymeric bonding film. The polymeric bonding film can be implemented over the entire surface or over only part of the surface in the sub-region of the textile film. In the sub-region that is not to be provided with the textile film, one or more additional polymeric laminating films can be inserted into the arrangement in order to form a film package with approx. the same thickness between the two panes. The arrangement is then laminated in a conventional manner by applying pressure and/or heat to form the vehicle composite glass according to the invention. After lamination, the polymeric intermediate layer film forms the polymeric intermediate layer and the polymeric bonding film forms the polymeric bonding layer.

The following statements apply to both variants described above, unless otherwise specified.

The improved stiffness is achieved, in particular, in the region of the vehicle composite glass to which the textile film is adhered or in which the textile film is laminated. Particularly advantageously, the textile film is arranged in the edge region of the textile film, since stiffening of the vehicle composite glass in the edge region or at the edges is particularly advantageous.

In a preferred embodiment, the textile film is, consequently, positioned in a edge region of the vehicle composite glass, in particular, up to the edge. The textile film is preferably arranged circumferentially around the entire edge region of the vehicle composite glass. The textile film is; consequently, preferably frame-shaped. This offers the advantage that the textile film can replace the otherwise customary opaque coating on the vehicle composite glass as visual cover for concealing unsightly elements.

Optionally, two or more textile films can also in each case be adhered on a sub-region of the outer pane or the inner pane of the vehicle composite glass or in each case be laminated in a sub-region between the polymeric intermediate layer and the outer pane or the inner pane. Thus, for example, around the entire edge region of the vehicle composite glass, a frame-shaped circumferential region that is provided with the textile film can also be composed of; for example, four individual textile films, with, however, a single textile film in the form of a frame being preferred.

As described above, even in the case of a circumferential arrangement around the entire edge region of the vehicle composite glass, the textile film or the two or more textile films do not protrude beyond the outer pane and the inner pane of the vehicle composite glass and also do not enclose one or more side edges of the outer pane or the inner pane.

The vehicle composite glass usually has a through-vision region that is not provided with textile film. The through-vision region constitutes, for example, at least 50%, preferably at least 60%, of the area of the vehicle composite glass.

In a preferred embodiment, the vehicle composite glass has no opaque coating, in particular, no black coating, such as a black masking print, on the outer pane and the inner pane in the edge region.

The vehicle composite glass can also include a functional element and/or an additional functional layer, which are customary in the field. These can be, for example, functional layers on the panes, which were described above. Additional functional layers are, for example, acoustic layers or infrared (IR)-reflecting layers. Acoustic layers are, for example, composed of multiple PVB layers. Since the acoustic layers are also suitable as laminating layers, they can perform a dual function. IR-reflecting layers are, for example, formed from a polymeric carrier layer and an IR-reflecting coating situated thereon. Also conceivable are electrically conductive functional layers or functional elements.

The vehicle composite glass according to the invention is suitable in particular as a vehicle window for motor vehicles or transport vehicles. The vehicle window can, for example, be a rear window, side window, windshield, or roof panel, in particular, for automobiles. Particularly preferably, the vehicle composite glass according to the invention is a roof panel. The vehicle composite glasses according to the invention are suitable, for example, as roof panels for lightweight roof structures, since as a result of the improved mechanical stiffness of the vehicle composite glasses according to the invention glass, thickness can be reduced.

The invention also relates to the use of the vehicle composite glass according to the invention as a vehicle window, e.g., as a rear window, side window, windshield, or roof panel, preferably as a roof panel of a motor vehicle.

The invention also relates to the use of a textile film, comprising a textile in a plastic matrix, on or in a vehicle composite glass for decorative processes and/or as visual cover and/or for additional stiffening of the vehicle composite glass. Use as textile film laminated into the vehicle composite glass is preferred. All statements above concerning the vehicle composite glass according to the invention apply analogously to the use according to the invention such that references made thereto.

The invention is further explained in the following using nonrestrictive exemplary embodiments and referring to the accompanying drawings. The drawings are schematic and not to-scale. They depict:

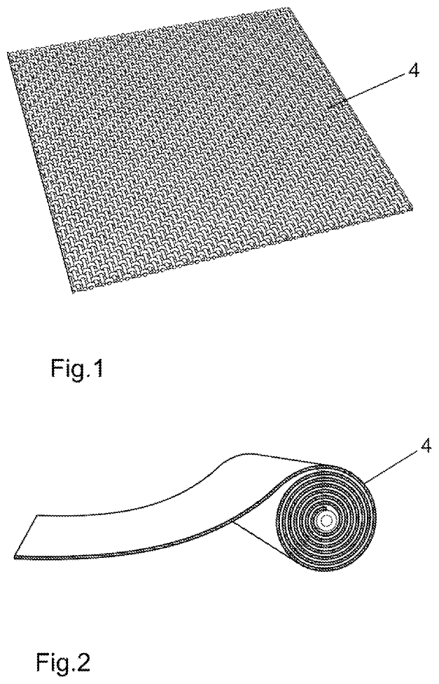

FIG. 1 a plan view of a textile film,

FIG. 2 a textile film as a rolled product,

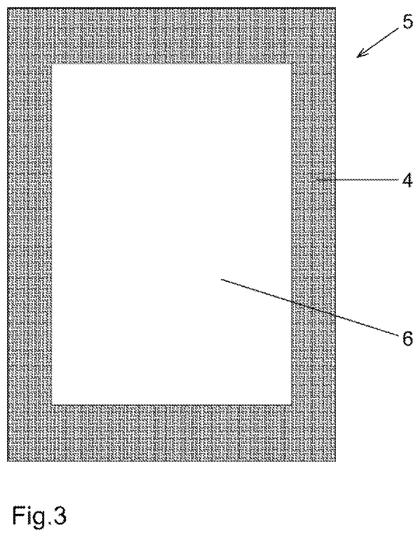

FIG. 3 a plan view of a vehicle composite glass according to the invention,

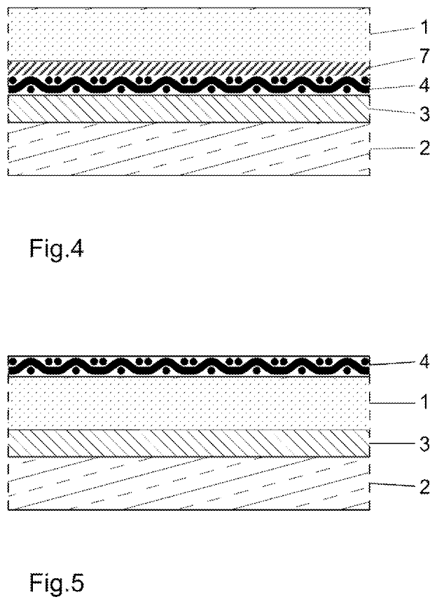

FIG. 4 a cross-section of a detail of a vehicle composite glass according to the invention, and

FIG. 5 a cross-section of a detail of another vehicle composite glass according to the invention.

FIG. 1 depicts a plan view of a textile film 4 in the form of a carbon fiber film as it is commercially available. The carbon fiber film has a woven fabric made of carbon fibers. The woven fabric is embedded a plastic matrix. The carbon fiber film is opaque. The carbon fiber film has a decorative pattern.

FIG. 2 depicts a textile film 4 in the form of a carbon fiber film as a rolled product as it is commercially available.

FIG. 3 depicts a plan view of a vehicle composite glass 5 according to the invention. The vehicle composite glass 5 has, circumferentially around the edge region, a textile film 4 in accordance with FIG. 1 in the form of a frame. The through-vision region 6 is situated in the central region of the vehicle composite glass 5. The frame-like textile film 4 can be laminated into the vehicle composite glass 5 (see FIG. 4) or adhered on the vehicle composite glass 5 (see FIG. 5). The textile film 4 gives the vehicle composite glass 5 a decorative appearance. The textile film is, for example, an opaque carbon fiber film. With the use of an opaque textile film, unsightly elements, such as mechanical parts, seals, glued bonds, or cables, can also be visually concealed when installed in a vehicle such that the otherwise customary visual cover by means of a black print in the edge region of the vehicle composite glass is not required. The vehicle composite glass is suitable, for example, as a roof panel for the lightweight roof structure of a car.

FIG. 4 depicts a cross-section of a detail of the vehicle composite glass according to the invention in accordance with one variant of FIG. 3 in a sub-region that is provided with the laminated-in textile film 4. The vehicle composite glass has, in this detail, in this order, an inner pane 2, a polymeric intermediate layer 3, the textile film 4, a polymeric bonding layer 7, and an outer pane 1. The inner pane 2 and the outer pane 1 are made of soda lime glass. The polymeric intermediate layer 3 is, for example, a PVB film with a thickness of 0.76 mm. The polymeric bonding layer 7 is, for example, a PVB film with a thickness of 0.38 mm. The textile film 4 is, for example, a carbon fiber film with a thickness of 0.4 mm. As a result of laminating the textile film 4 into the composite, increased stiffness of the vehicle composite glass is achieved, in particular in the edge region or at the edges.

FIG. 5 depicts a cross-section of a detail of the vehicle composite glass according to the invention in accordance with one variant of FIG. 3 in a sub-region that is provided with an adhered textile film 4. The vehicle composite glass has, in this detail, in this order, an inner pane 2, a polymeric intermediate layer 3, and an outer pane 1. The inner pane 2 and the outer pane 1 are made of soda lime glass. The polymeric intermediate layer 3 is, for example, a PVB film with a thickness of 0.76 mm. The textile film 4 is, for example, a carbon fiber film with a thickness of 0.4 mm. The textile film 4 is adhered with an adhesive on the outer pane 1 (adhesive layer not shown). As a result of the adhering of the textile film 4, increased stiffness of the vehicle composite glass is also achieved; however stiffening due to lamination of the textile film 4 is more significant.

### LIST OF REFERENCE CHARACTERS

1 outer pane
2 inner pane
3 polymeric intermediate layer
4 textile film
5 vehicle composite glass
6 through-vision region
7 polymeric bonding layer

1. A vehicle composite glass, comprising an outer pane, an inner pane, at least one polymeric intermediate layer which is arranged between the outer pane and the inner pane, and a textile film which comprises a colored or dyed textile in a plastic matrix, wherein the textile film is adhered on a sub-region of the outer pane or the inner pane of the vehicle composite glass or is laminated in a sub-region between the polymeric intermediate layer and the outer pane or the inner pane.

2. The vehicle composite glass according to claim 1, wherein the textile is formed from inorganic or organic fibers.

3. The vehicle composite glass according to claim 1, wherein the textile is formed from black fibers.

4. The vehicle composite glass according to claim 1, wherein the textile film is a carbon fiber film.

5. The vehicle composite glass according to claim 1, wherein the textile film is opaque.

6. The vehicle composite glass according to claim 1, wherein the textile film is adhered on the sub-region of the outer pane or the inner pane of the vehicle composite glass.

7. The vehicle composite glass according to claim 1, wherein, when the textile film is laminated between the polymeric intermediate layer and the outer pane, a polymeric bonding layer is arranged between the textile film and the outer pane, or, when the textile film is laminated between the polymeric intermediate layer and the inner pane, a polymeric bonding layer is arranged between the textile film and the inner pane.

8. The vehicle composite glass according to claim 7, wherein the polymeric bonding layer is implemented over an entire surface in the vehicle composite glass or over part of a surface in the sub-region of the textile film.

9. The vehicle composite glass according to claim 1, wherein the textile film is positioned in an edge region of the vehicle composite glass.

10. The vehicle composite glass according to claim 1, wherein the textile film is frame-shaped.

11. The vehicle composite glass according to claim 1, wherein two or more textile films are, in each case, adhered on a sub-region of the outer pane or the inner pane of the vehicle composite glass or are, in each case, laminated in a sub-region between the polymeric intermediate layer and the outer pane or the inner pane.

12. The vehicle composite glass according to claim 1, wherein the outer pane and the inner pane have no black coating in an edge region of the vehicle composite glass.

13. The vehicle composite glass according to claim 1, wherein the vehicle composite glass further includes a functional element or an additional functional layer.

14. The vehicle composite glass according to claim 1, wherein the vehicle composite glass is a rear window, side window, windshield, or roof panel.

15. A method comprising utilizing a vehicle composite glass according to claim 1 as a roof panel of a motor vehicle.

16. The vehicle composite glass according to claim 2, wherein the fibers are selected from carbon fibers, glass fibers, or aramide fibers.

17. The vehicle composite glass according to claim 9, wherein the textile film is arranged circumferentially around the entire edge region of the vehicle composite glass.
